(19) United States
(12) Patent Application Publication
(10) Pub. No.: US 2024/0288553 A1
(43) Pub. Date: Aug. 29, 2024

(54) LIDAR CONTROLLING METHOD AND APPARATUS, TERMINAL DEVICE AND COMPUTER-READABLE STORAGE MEDIUM

(71) Applicant: SUTENG INNOVATION TECHNOLOGY CO., LTD., Shenzhen (CN)

(72) Inventor: Changsheng GONG, Shenzhen (CN)

(73) Assignee: SUTENG INNOVATION TECHNOLOGY CO., LTD., Shenzhen (CN)

(21) Appl. No.: 18/515,225

(22) Filed: Nov. 20, 2023

(30) Foreign Application Priority Data
Nov. 24, 2022 (CN) 202211482542.8

(51) Int. Cl. G01S 7/484; G01S 7/487

(52) U.S. Cl. CPC G01S 7/484; G01S 7/487

(57) ABSTRACT

This application provides a LiDAR controlling method and apparatus, a terminal device, and a computer-readable storage medium. The method includes: obtaining an emission policy of a current emission block based on a current measurement scenario; and controlling, by the LiDAR, the current emission block to emit the laser detection signal based on the emission policy.

### CROSS-REFERENCE TO RELATED APPLICATION

The present application claims the benefit of priority to Chinese Patent Application No. 202211482542.8, filed on Nov. 24, 2022, which is hereby incorporated by reference in its entirety.

### TECHNICAL FIELD

This application pertains to the field of Light Detection and Ranging (LiDAR) technology, and in particular, relates to a LiDAR controlling method, a terminal device, and a computer-readable storage medium.

### TECHNICAL BACKGROUND

LiDARs are usually used in fields such as automated driving, transport vehicles, robots, and public smart transportation due to their advantages such as high resolution, high sensitivity, strong anti-interference ability, and all-weather availability.

However, the existing LiDAR has difficulty in satisfying requirements for performance such as ranging performance, ranging accuracy and high anti-expansion performance in all the short-to-long distance measurement scenarios. That is, the existing LiDAR has a problem of poor measurement performance.

### SUMMARY

Embodiments of this application provide a LiDAR controlling method and apparatus, a terminal device and a computer-readable storage medium, to resolve a problem of poor measurement performance of existing LiDAR.

According to a first aspect, an embodiment of this application provides a LiDAR controlling method, including:
obtaining an emission policy of a current emission block based on a current measurement scenario, where the emission policy includes the number of emissions performed by the current emission block and emission power for emitting a laser detection signal each time; and controlling, by the LiDAR, the current emission block to emit the laser detection signal based on the emission policy.

In an embodiment, the emission block includes one or more emission units.

In an embodiment, when the LiDAR includes an emission array, the emission array includes several groups of parallel emission blocks, and each group of parallel emission blocks emit laser detection signals via the same emission policy.

In an embodiment, when the emission array uses a planar array for emission, emission blocks located in different regions have different emission policies.

In an embodiment, after controlling, by the LiDAR, the current emission block to emit the laser detection signal based on the emission policy, the method further includes: adjusting the emission policy of the current emission block in a next measurement cycle based on a measurement result in the current measurement cycle.

In an embodiment, when the emission policy is a first emission policy, controlling the current emission block to emit the laser detection signal based on the emission policy includes: controlling the current emission block to emit the laser detection signal at least twice, where the emission power for emitting the laser detection signal each time is fixed power, and equal emission power is used for emitting the laser detection signal each time.

In an embodiment, when the emission policy is a second emission policy, controlling the current emission block to emit the laser detection signal based on the emission policy includes: controlling the current emission block to emit the laser detection signal at least twice, where the emission power for emitting the laser detection signal each time is fixed power, and different emission power is used for emitting the laser detection signal each time.

In an embodiment, when the emission policy is a third emission policy, controlling the LiDAR to emit the laser detection signal based on the emission policy includes:
adjusting a subsequent emission policy based on a first echo signal in a current detection cycle, where the first echo signal is an echo signal received by the LiDAR when a laser detection signal is emitted for the first time in the current detection cycle.

In an embodiment, before adjusting a subsequent emission policy based on a first echo signal in a current detection cycle, the method further includes: determining whether the first echo signal meets a detection requirement; and if the first echo signal meets the detection requirement, stopping emitting the laser detection signal; or if the first echo signal does not meet the detection requirement, performing a step of adjusting the subsequent emission policy based on the first echo signal in the current detection cycle.

According to a second aspect, an embodiment of this application provides a LiDAR controlling apparatus, including: a determining module, configured to obtain an emission policy of a current emission block based on a current measurement scenario, where the emission policy includes the number of emissions performed by the current emission block and emission power for emitting a laser detection signal each time; and a control module, configured to be used by the LiDAR to control the current emission block to emit the laser detection signal based on the emission policy.

According to a third aspect, an embodiment of this application provides a terminal device, where the terminal device includes a processor, a memory, and a computer program stored in the memory and capable of running on the processor, where when the processor executes the computer program, the LiDAR controlling method according to the first aspect or any one of the optional embodiments of the first aspect is implemented.

According to a fourth aspect, an embodiment of this application provides a computer-readable storage medium, where the computer-readable storage medium stores a computer program, and when the computer program is executed by a processor, the LiDAR controlling method according to the first aspect or any one of the optional embodiments of the first aspect is implemented.

According to a fifth aspect, an embodiment of this application provides a computer program product, where when the computer program product runs on a terminal device, the terminal device performs the LiDAR controlling method according to the first aspect or any optional embodiment of the first aspect.

In the LiDAR controlling method provided in the embodiments of this application, the number of emissions of laser detection signals performed by the current emission block and the emission power for emitting the laser detection signal each time can be adjusted based on the current measurement scenario, so that the emitted laser detection signal can meet a requirement for the current measurement scenario. By adjusting the number of emissions of the laser detection signals performed by the current emission block and the emission power for emitting the laser detection signal each time, the LiDAR can meet performance requirements such as the ranging performance, the ranging accuracy, and the high anti-expansion performance in various measurement scenarios, thereby improving the measurement performance of the LiDAR.

### BRIEF DESCRIPTION OF DRAWINGS

To explain the technical solution in embodiments in this application, the following briefly introduces the accompanying drawings required to describe the embodiments or the related art. Obviously, the accompanying drawings in the following description are only some embodiments in this application.

FIG. 1 is a schematic diagram of an application scenario of an existing LiDAR;

FIG. 2 is a schematic flowchart of implementation of a LiDAR controlling method according to an embodiment;

FIG. 3 is a schematic structural diagram of an emission array of a LiDAR according to an embodiment;

FIG. 4 is a schematic diagram of a first emission policy according to an embodiment;

FIG. 5 is a schematic diagram of a second emission policy according to an embodiment;

FIG. 6 is a schematic diagram of a third emission policy according to an embodiment;

FIG. 7 is another schematic diagram of a third emission policy according to an embodiment;

FIG. 8 is still another schematic diagram of a third emission policy according to an embodiment;

FIG. 9 is a schematic structural diagram of a LiDAR controlling apparatus according to an embodiment; and

FIG. 10 is a schematic structural diagram of a terminal device according to an embodiment.

### DETAILED DESCRIPTION

For the purpose of illustration rather than limitation, the following describes details such as a system structure and technology, to facilitate a thorough understanding of the embodiments of this application. Detailed descriptions of well-known systems, apparatuses, circuits, and methods are omitted for purpose of brevity while not preventing a person skilled in the art from carrying out the embodiments contained herein.

The term “and/or” used in this specification and appended claims of this application refers to any combination of one or more of the associated items listed and all possible combinations thereof, and inclusion of these combinations. In addition, in the descriptions of this specification and the appended claims of this application, the terms “first”, “second”, “third” and the like are merely intended for differential description, and should not be understood as any indication or implication of relative importance.

Reference to “an embodiment”, “some embodiments”, or the like described in this specification of this application means that one or more embodiments of this application include a feature, structure, or characteristic described with reference to the embodiments. Therefore, expressions such as “in an embodiment”, “in some embodiments”, “in some other embodiments”, and “in some additional embodiments” appearing in different places in this specification do not necessarily indicate reference to the same embodiment, but mean “one or more but not all embodiments”, unless otherwise specified in another way. The terms “include”, “comprise”, “have”, and variants thereof all mean “including but not limited to”, unless otherwise specified in another way.

A LiDAR is an automated remote sensing device for detection using a laser as an emitting light source and a photoelectric detection technology. The LiDAR can include parts such as an emission array, a receiving array, a scanning control system, and a data processing system. A working principle of the LiDAR is that a laser detection signal is emitted to the target object, and after the laser detection signal reaches the target object, the target object reflects the laser detection signal to form an echo signal, and the receiving array can receive the echo signal and process the received echo signal, to obtain information such as distance, size, speed, and reflectivity of the target object.

The existing LiDAR usually only emits a laser detection signal once in a measurement cycle, then receives an echo signal corresponding to the laser detection signal, and analyzes the echo signal to obtain a measurement result.

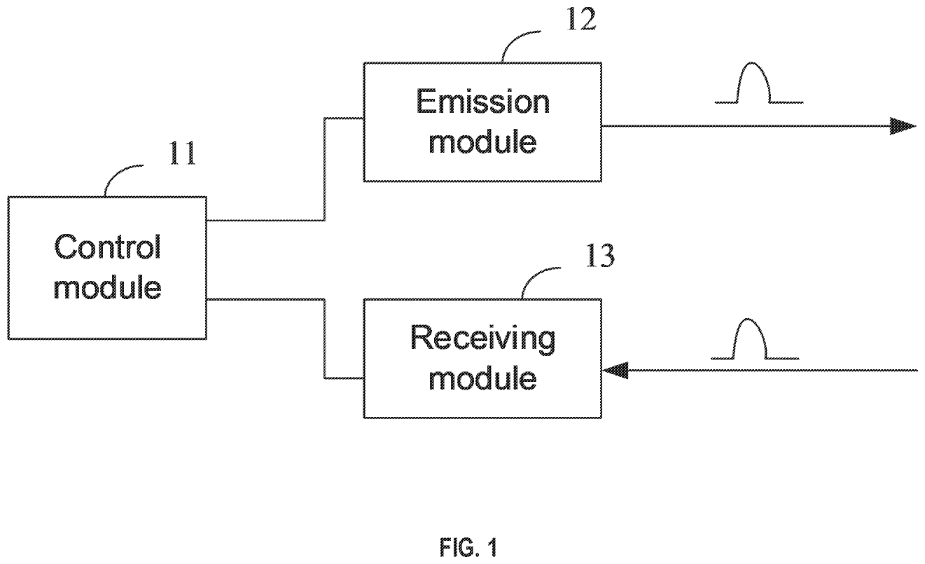

Exemplarily, referring to FIG. 1, FIG. 1 is a schematic diagram of an application scenario of an existing LiDAR. As shown in FIG. 1, the LiDAR may include a control module 11, an emission module 12, and a receiving module 13. The control module 11 is connected to the emission module 12 and the receiving module 13 separately.

In one measurement cycle, the LiDAR controls the emission module 12 through the control module 11 to emit a laser detection signal once to detect the target object. In a case where the laser detection signal detects the target object, the target object reflects an echo signal. The receiving module 13 receives the echo signal reflected by the target object, then the control module 11 processes and analyzes the echo signal, and therefore, information such as movement direction, movement speed, and distance of the target object relative to the LiDAR can be determined. That is, the laser detection signal only needs to be emitted once to obtain the measurement result.

The foregoing execution body of processing and analyzing the echo signal to determine the information such as movement direction, movement speed and distance of the target object relative to the LiDAR can also be another apparatus, module, or terminal with a data processing capability and a data analysis capability. For example, the execution body can be a data processing module (not shown in FIG. 1) in the LiDAR, or an electronic device such as a vehicle-mounted terminal and/or a mobile terminal that is communicatively connected to the LiDAR.

The LiDAR usually has problems of an oversaturation phenomenon and a high anti-expansion phenomenon. The oversaturation phenomenon means that with the same emission power, when the target object is closer to the LiDAR, energy of the echo signal reflected by the target object becomes larger, which causes the oversaturation phenomenon for the echo signal received by the LiDAR. The oversaturation phenomenon causes a measurement result to be inaccurate. The high anti-expansion phenomenon refers to a high anti-expansion phenomenon that occurs because power of the reflected echo signal is excessively large when the target object is an object with high reflectivity. The high anti-expansion phenomenon can also cause a measurement result to be inaccurate.

To improve the measurement accuracy, the emission power is usually reduced. However, reducing the emission power affects ranging performance and ranging accuracy of the LiDAR. In addition, the LiDAR often has blind spots when detecting objects at short and long distances, which also causes the measurement result to be inaccurate.

In summary, it can be seen that the existing LiDAR has the problem of poor measurement performance.

In the LiDAR controlling method provided in the embodiments of this application, the number of emissions of laser detection signals performed by the current emission block and the emission power for emitting the laser detection signal each time can be determined based on the current measurement scenario, so that the emitted laser detection signal can meet a requirement for the current measurement scenario. By adjusting the number of emissions of the emitted laser detection signals and the emission power for emitting the laser detection signal each time, the LiDAR can meet performance requirements in various measurement scenarios, thereby improving the measurement performance of the LiDAR.

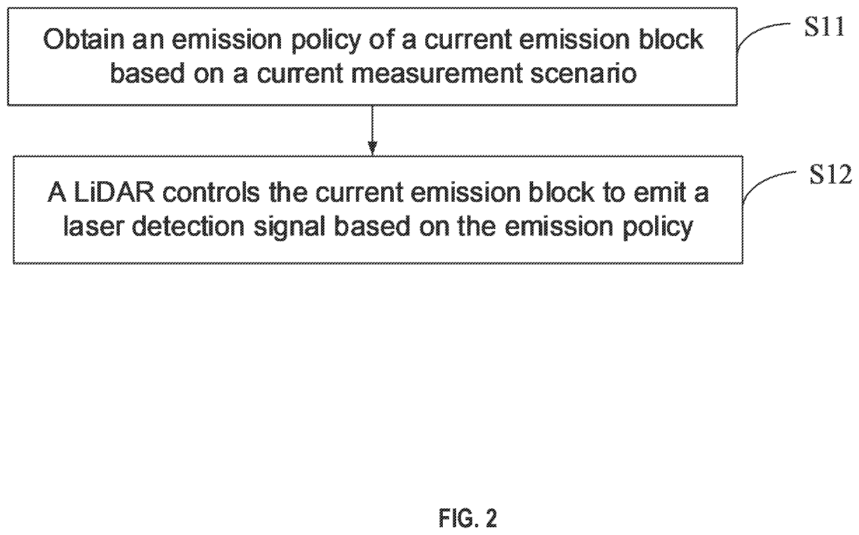

In an embodiment, FIG. 2 is a schematic flowchart of a LiDAR controlling method according to an embodiment of this application. An execution body of the LiDAR controlling method provided in this embodiment of this application may be the LiDAR, a control system or a module inside the LiDAR, or a terminal device that is communicatively connected to the LiDAR. The terminal device may be a mobile terminal such as smartphone, tablet computer, or wearable device, or may be a device such as computer, cloud server, or LiDAR-assisted computer in various application scenarios. An example using the LiDAR as the execution body is used for description below.

As shown in FIG. 2, the LiDAR controlling method provided in this embodiment of this application may include step S11 to step S12.

S11. Obtain an emission policy of a current emission block based on a current measurement scenario.

In an embodiment, the foregoing emission policy includes the number of emissions of laser detection signals performed by the current emission block in the current measurement cycle and emission power for emitting the laser detection signal each time.

In an embodiment, based on a current measurement scenario, the LiDAR can determine the number of emissions of laser detection signals performed by the current emission block in the current measurement cycle and the emission power for emitting the laser detection signal each time.

In an embodiment, the measurement scenario of the current emission block can be determined based on the position and detection requirement of the current emission block. For example, when a detection requirement is to detect objects at different distances and/or with different reflectivities based on emission blocks at different positions, a measurement scenario of the current emission block can be determined as a multi-distance measurement scenario. When the LiDAR has a high measurement accuracy function and there is a high measurement accuracy requirement, a measurement scenario of the current emission block can be determined as a high-accuracy measurement scenario. Or when an object with unknown reflectivity or at an unknown distance is detected, a measurement scenario of the current emission block can be determined as a real-time adjustment measurement scenario, and so on.

Different measurement scenarios can correspond to the same or different emission policies of emission blocks at different positions. Therefore, when the emission policy of the current emission block is determined, it is necessary to determine the position of the current emission block. Then the position of the current emission block is determined with reference to the current measurement scenario.

In an embodiment, the foregoing emission block may include one or more emission units. Determining the emission policy of the current emission block may be determining an emission policy of each emission unit in the emission block.

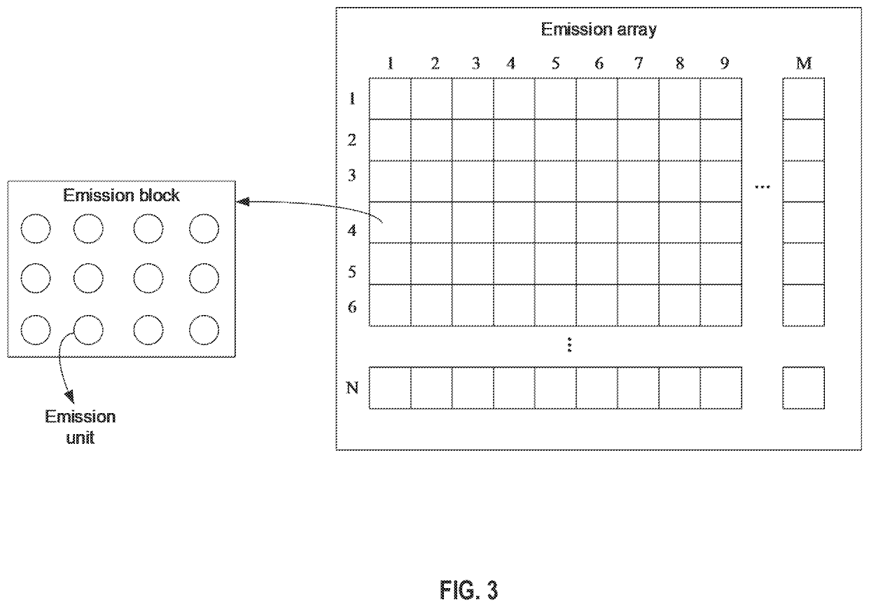

In an embodiment, FIG. 3 is a schematic diagram of an emission array of a LiDAR.

According to FIG. 3, each emission block may include one or more emission units. In one emission block, each emission unit uses the same emission policy.

In an embodiment, the emission array may include several groups of parallel emission blocks, and each group of parallel emission blocks emit laser detection signals via the same emission policy.

In an embodiment, a grouping method of parallel emissions can be determined based on an actual application scenario. Emission blocks in the same group use the same emission policy, and emission blocks in different groups use different emission policies.

In an embodiment, when the emission array uses a planar array for emission, emission blocks located in different regions have different emission policies.

For example, the first three rows of emission blocks in FIG. 3 can use one emission policy (for example, an emission policy for a short-distance measurement scenario), emission blocks in the middle position (for example, rows 4 to N-4) can use another emission policy (for example, an emission policy for a long-distance measurement scenario), and emission blocks in the last three rows can use the emission policy corresponding to the emission blocks in the first three rows.

The foregoing measurement scenarios can be other scenarios. The multi-distance measurement scenario, the high-accuracy measurement scenario, the real-time adjustment measurement scenario and the like mentioned above are only used as examples but not as a limitation. For example, the foregoing measurement scenario can also be a long-distance measurement scenario, a short-distance measurement scenario, a mid-distance measurement scenario, a high reflective object measurement scenario, a low reflective object measurement scenario, or the like.

The long distance, the short distance and the middle distance mentioned in an embodiment can be determined based on device parameters of the LiDAR. For example, a measurement region that is more than 10 m away from the LiDAR can be set as the long-distance measurement region; a measurement region that is less than 3 m away from the LiDAR is set as the short-distance measurement region; and the measurement region that is 3 m to 10 m away from the LiDAR is set as the mid-distance measurement region. Correspondingly, the foregoing long-distance measurement scenario refers to a measurement scenario in which a target object in the long-distance measurement region is detected; the foregoing short-distance measurement scenario refers to a measurement scenario in which the target object in the short-distance measurement region is detected; and the foregoing mid-distance measurement scenario refers to a measurement scenario in which a target object within the mid-distance measurement region is detected.

In an embodiment, the emission policy of the current emission block can be set to be corresponding to the foregoing measurement scenario. That is, different emission policies of the current emission block can be set based on different measurement scenarios. For example, with respect to the emission block in the middle, for the high-accuracy measurement scenario, the first emission policy can be set as the emission policy; for the multi-distance measurement scenario, the second emission policy can be set; and for the real-time adjustment measurement scenario, the third emission policy can be set.

The first emission policy may be controlling the current emission block to emit the laser detection signal at least twice within one measurement cycle, where the emission power for emitting the laser detection signal each time is fixed power, and equal emission power is used for emitting the laser detection signal each time.

Laser detection signals with the same emission power are emitted at least twice, and then information such as a distance of the target object is determined by using the echo signals corresponding to the laser detection signals emitted twice, which can effectively improve ranging accuracy of the current emission block, so that the LiDAR meets a service requirement for high-accuracy measurement.

The emission power for emitting a laser detection signal each time and the number of emissions of the laser detection signals can be set based on requirements for performance, accuracy, and the like of the LiDAR.

For example, the foregoing first emission policy may be a fixed-power dual-emission policy, a fixed-power triple-emission policy, a fixed-power quadri-emission policy, or the like.

The fixed power in the first emission policy can be determined based on various conditions, including but not limited to: various conditions such as a long-distance ranging capability, a short-distance ranging capability and a leader simulation capability required by a product. Generally, the greater the requirement for the ranging capability is, the higher the fixed power can be set; or conversely, the lower the requirement for the ranging capability is, the lower the fixed power can be set.

The second emission policy may be controlling the current emission block to emit the laser detection signal at least twice within one measurement cycle, where the emission power for emitting the laser detection signal each time is fixed power, and different emission power is used for emitting the laser detection signal each time.

Laser detection signals with different emission power are emitted at least twice, and information such as a distance of the target object is analyzed by using the echo signals corresponding to different laser detection signals, which can detect target objects at different distances and target objects with different reflectivities, so that the LiDAR meets a service requirement for multi-distance measurement.

Similarly, the emission power for emitting each laser detection signal and the number of emissions of the laser detection signals can be set based on requirements for performance, accuracy, and the like of the LiDAR.

For example, if an object at a short distance and an object at along distance need to be detected simultaneously, the second emission policy can be determined as emitting a laser detection signal with first fixed power once and emitting a laser detection signal with second fixed power once. The first fixed power is emission power corresponding to short-distance detection, and the second fixed power is emission power for long-distance detection. Generally, the first fixed power is less than the second fixed power.

In an embodiment, when objects at the short distance, the middle distance, and the long distance need to be detected simultaneously, the second emission policy can be determined as emitting a laser detection signal with the first fixed power once, emitting a laser detection signal with the second fixed power once and emitting a laser detection signal with third fixed power once. The first fixed power is emission power corresponding to short-distance detection, the second fixed power is emission power for long-distance detection, and the third fixed power is emission power for mid-distance detection. Generally, the first fixed power is less than the third fixed power and the third fixed power is less than the second fixed power. A sequence of the first emission power, the second emission power and the third emission power during emission is set based on a specific requirement. A sequence of the foregoing first fixed power, second fixed power and third fixed power during emission can be set for the LiDAR.

The third emission policy may be set as controlling the current emission block within a measurement cycle to adjust the subsequent emission policy based on the first echo signal in the current detection cycle. The first echo signal is an echo signal received by the LiDAR after the laser detection signal emitted with the first preset emission power is reflected by the target object.

The foregoing first preset emission power can be determined based on actual application. Specifically, the foregoing first preset emission power may be fixed emission power set in advance, or may be adjustable emission power set based on a measurement result in a previous measurement cycle.

In an embodiment, the foregoing third emission policy may also include: emitting the laser detection signal with the first preset emission power within a measurement cycle, and based on the first echo signal, determining whether to emit the laser detection signal again; and if the laser detection signal needs to be emitted again, adjusting the emission power for the laser detection signal based on the first echo signal, and then emitting the laser detection signal for detection with the adjusted emission power; or if the laser detection signal does not need to be emitted again, completing a measurement task within the measurement cycle and analyzing the measurement result based on the first echo signal.

In an embodiment, if an echo signal (hereinafter referred to as the second echo signal) corresponding to the laser detection signal emitted with the adjusted emission power does not meet the detection requirement, the emission power is further adjusted based on the second echo signal, and then the laser detection signal is emitted with the adjusted emission power until the echo signal meets the detection requirement.

In an embodiment, the current emission block may also be provided with various emission policies corresponding to other measurement scenarios, and the current emission block may determine the emission policy corresponding to the current measurement scenario based on the current measurement scenario. For example, the current emission block may also be provided with emission policies such as a fourth emission policy corresponding to a long-distance measurement scenario and a fifth emission policy corresponding to a short-distance measurement scenario. The fourth emission policy may be an emission policy of emitting the laser detection signal with the second fixed power, and the fifth emission policy may be an emission policy of emitting the laser detection signal with the first fixed power. When the current emission block determines that the current measurement scenario is a long-distance measurement scenario, the corresponding emission policy can be determined as the fourth emission policy.

S12. A LiDAR controls the current emission block to emit a laser detection signal based on the emission policy.

In an embodiment, after the LiDAR determines the emission policy for the current emission block, the current emission block can be controlled to emit a laser detection signal based on the number of emissions of the laser detection signals and the emission power for emitting the laser detection signal each time in the emission policy.

In an embodiment, when the foregoing emission policy is the first emission policy, step S12 may include: controlling the current emission block to emit the laser detection signal at least twice, where the emission power for emitting the laser detection signal each time is fixed power, and equal emission power is used for emitting the laser detection signal each time.

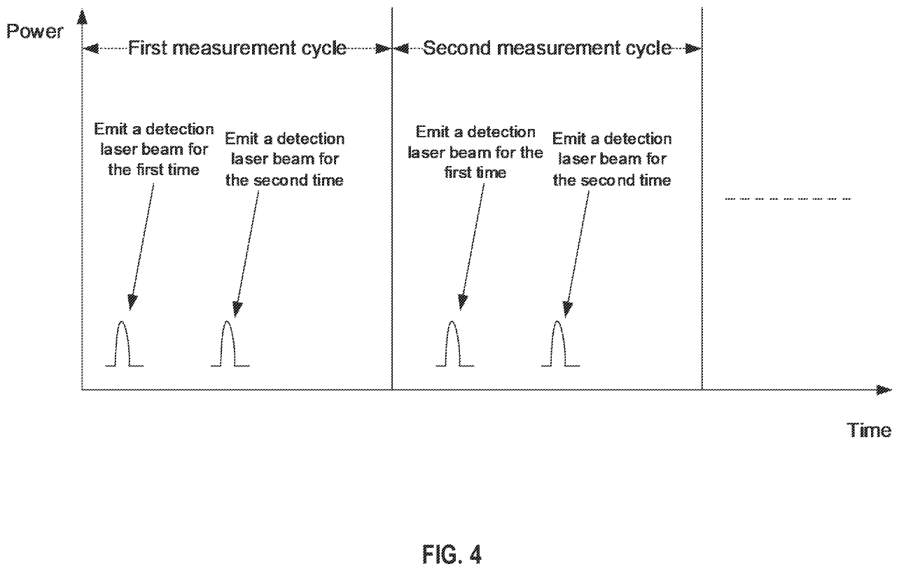

In an embodiment, FIG. 4 is a schematic diagram of a first emission policy according to an embodiment of this application. The abscissa in FIG. 4 represents time, and the ordinate represents the emission power for the laser detection signal. As shown in FIG. 4, in the first measurement cycle, the current emission block is first controlled to emit the laser detection signal first time with the first fixed power (or certainly other fixed power), and then the current emission block is also controlled to emit the laser detection signal second time still with the first fixed power; and in the second measurement cycle, the current emission block is also first controlled to emit the laser detection signal first time with the first fixed power (or certainly other fixed power), and then the current emission block is also controlled to emit the laser detection signal second time still with the first fixed power and so on until the measurement is completed.

The foregoing first emission policy can also be an emission policy of emitting laser detection signals with the same fixed power three times in the same measurement cycle, or an emission policy of emitting laser detection signals with the same fixed power four times in the same measurement cycle. At this time, the LiDAR emits laser detection signals with the same fixed power for a corresponding number of times in the same measurement cycle.

The greater the number of emissions, the higher the ranging accuracy of the LiDAR and the higher the energy loss of the LiDAR. Therefore, the number of times of emitting laser detection signals with the same fixed power within the same measurement cycle can be properly set based on a ranging accuracy requirement and an energy consumption requirement.

In an embodiment, when the foregoing emission policy is the second emission policy, step S12 may include: controlling the current emission block to emit the laser detection signal at least twice, where the emission power for emitting the laser detection signal each time is fixed power, and different emission power is used for emitting the laser detection signal each time.

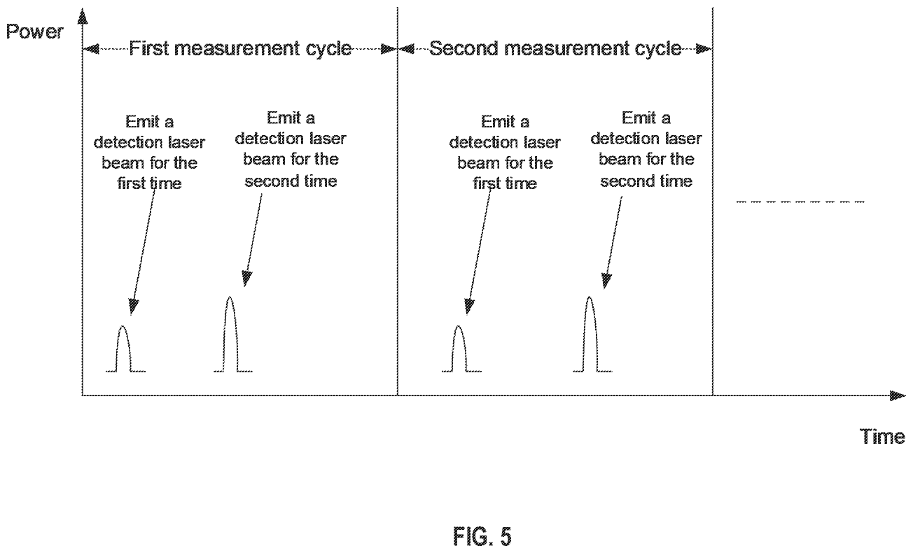

In an embodiment, FIG. 5 is a schematic diagram of a second emission policy according to an embodiment of this application. The abscissa in FIG. 5 represents time, and the ordinate represents the emission power for the laser detection signal. As shown in FIG. 5, in the first measurement cycle, the current emission block is first controlled to emit the laser detection signal first time with the first fixed power, and then the current emission block is also controlled to emit the laser detection signal second time still with the second fixed power; and in the second measurement cycle, the current emission block is also first controlled to emit the laser detection signal first time with the first fixed power, and then the current emission block is also controlled to emit the laser detection signal second time still with the second fixed power and so on until the measurement is completed.

The foregoing second emission policy can also be an emission policy of emitting laser detection signals with different fixed power three times in the same measurement cycle, or an emission policy of emitting laser detection signals with different fixed power four times in the same measurement cycle. At this time, the current emission block emits a corresponding laser detection signal based on the emission power for emitting the laser detection signal each time in the same measurement cycle.

The greater the number of emissions, the more the objects at different distances that can be detected by the LiDAR and the higher the energy loss of the LiDAR. Therefore, the number of times of emitting laser detection signals with the different fixed power and the emission power for emitting the laser detection signal each time within the same measurement cycle can be properly set based on a ranging requirement and an energy consumption requirement.

In an embodiment, when the emission policy is the third emission policy, the foregoing step S12 includes: adjusting the subsequent emission policy based on the first echo signal in the current detection cycle.

In an embodiment, the first echo signal may be an echo signal received by the LiDAR after the laser detection signal emitted by the current emission block with the first emission power under control is reflected by the target object.

In an embodiment, the first emission power can be preset according to actual application.

In an embodiment, adjusting a subsequent emission policy based on a first echo signal (hereinafter referred to as the first echo signal) in a current detection cycle includes: if signal amplitude of the first echo signal is excessively high, reducing the emission power; or if the signal amplitude of the first echo signal is excessively low, increasing the emission power. When the signal amplitude of the first echo signal is excessively high, it indicates that the echo intensity of the first echo signal is greater than a saturation intensity threshold, that is, the received first echo signals are oversaturated; and when the signal amplitude of the first echo signal is excessively low, it indicates that the echo intensity of the first echo signal is less than a measurement intensity threshold, that is, the first echo signal cannot meet the measurement requirement.

The echo intensity can be characterized by “echo amplitude, echo pulse width, an echo peak, an echo integral value, and the like.” One echo characteristic or a combination of multiple echo characteristics can be used to characterize the echo intensity and it is not limited herein.

The foregoing saturation intensity threshold and measurement intensity threshold can be set according to actual application and are not limited in this application.

In an embodiment, the reducing the emission power can be reducing the emission power based on preset unit power, that is, the emission power is reduced by preset unit power each time; and the increasing emission power can also be increasing the emission power based on preset unit power, that is, the emission power is increased by preset unit power each time. Reducing the emission power may also include: determining a power adjustment target value that needs to be reduced based on a difference between the echo intensity of the first echo signal and the saturation intensity threshold, and then controlling the LiDAR to reduce the foregoing power adjustment target value based on the first preset emission power. Increasing the emission power may also include: determining a power adjustment target value that needs to be increased based on a difference between the echo intensity of the first echo signal and the measurement intensity threshold, and then controlling the LiDAR to increase the foregoing power adjustment value based on the first preset emission power. Certainly, for the foregoing methods of increasing and reducing the emission power, refer to other methods of adjusting the emission power by the LiDAR.

Determining a power adjustment target value that needs to be reduced based on a difference between the echo intensity of the first echo signal and the saturation intensity threshold and determining a power adjustment target value that needs to be increased based on a difference between the echo intensity of the first echo signal and the measurement intensity threshold may include: presetting a corresponding relation between the difference and the power adjustment target value, and searching for the corresponding power adjustment target value based on the difference.

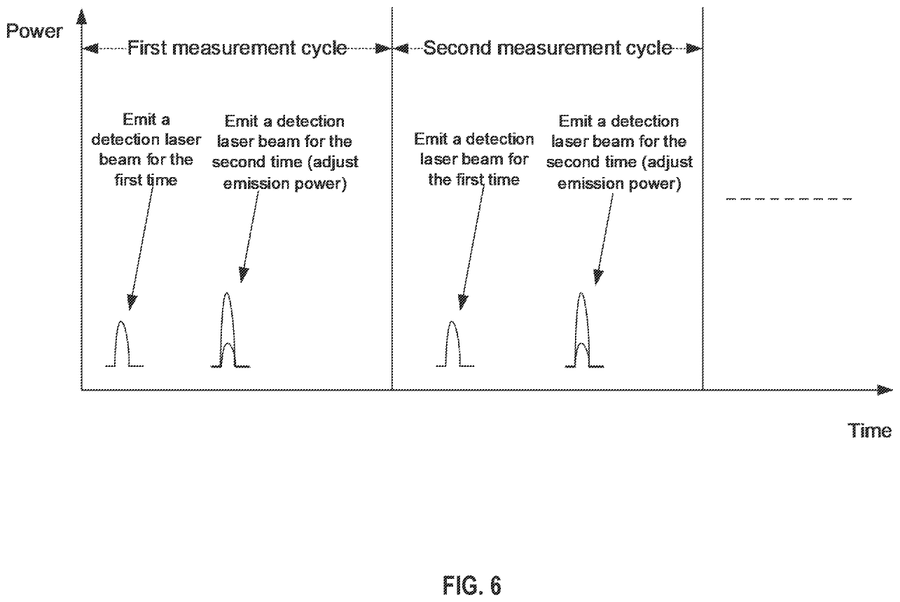

In an embodiment, FIG. 6 is a schematic diagram of a third emission policy according to an embodiment of this application. The abscissa in FIG. 6 represents time, and the ordinate represents the emission power for the laser detection signal. As shown in FIG. 6, in the first measurement cycle, the current emission block is first controlled to emit the laser detection signal first time with the first preset emission power (the first preset emission power in FIG. 6 is fixed power), and then the emission power for emitting the laser detection signal second time is adjusted based on the first echo signal corresponding to the laser detection signal emitted first time; and in the second measurement cycle, the current emission block is also first controlled to emit the laser detection signal first time with the first preset emission power, and then the emission power for emitting the laser detection signal second time is adjusted based on the first echo signal corresponding to the laser detection signal emitted first time and so on until the measurement is completed.

In an embodiment, before adjusting the emission power for the laser detection signal based on the first echo signal, and emitting the laser detection signal based on the adjusted emission power, the method may further include the following steps:
determining whether the first echo signal meets a detection requirement; and
if the first echo signal meets the detection requirement, stopping emitting the laser detection signal; or
if the first echo signal does not meet the detection requirement, performing steps of adjusting the emission power for the laser detection signal based on the first echo signal, and emitting the laser detection signal based on the adjusted emission power.

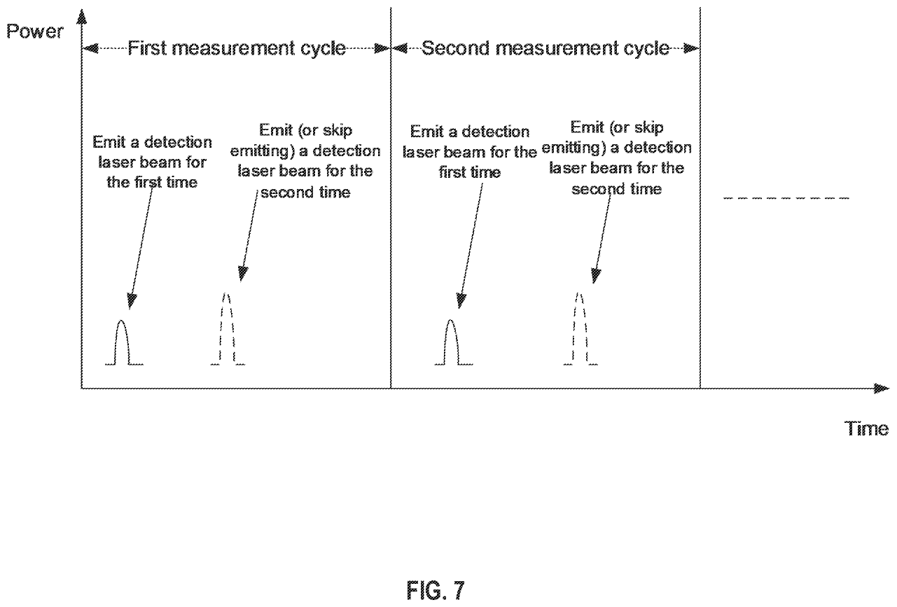

In an embodiment, FIG. 7 is another schematic diagram of a third emission policy according to an embodiment of this application. The abscissa in FIG. 7 represents time, and the ordinate represents the emission power for the laser detection signal. As shown in FIG. 7, in the first measurement cycle, the current emission block is first controlled to emit the laser detection signal first time with the first preset emission power (the first preset emission power in FIG. 7 is fixed power). Then based on the first echo signal corresponding to the laser detection signal emitted first time, it is determined whether the laser detection signal needs to be emitted second time, and if the laser detection signal needs to be emitted second time, the emission power for emitting the laser detection signal second time is adjusted based on the first echo signal corresponding to the laser detection signal emitted first time and so on until the measurement is completed.

In an embodiment, the foregoing first preset emission power may be fixed emission power set in advance, or may be adjustable emission power set based on a measurement result in a previous measurement cycle.

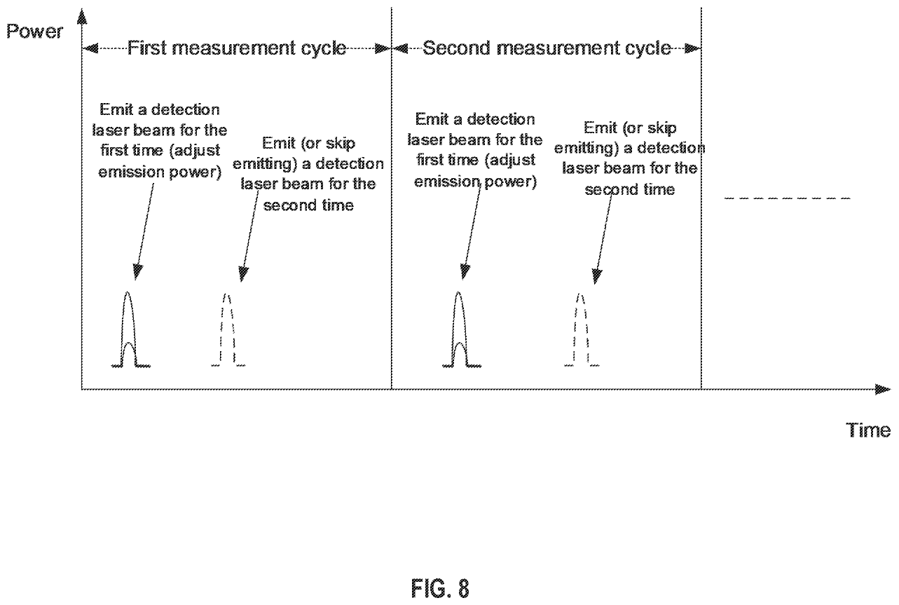

In an embodiment, FIG. 8 is a schematic diagram of a third emission policy according to an embodiment of this application. The abscissa in FIG. 8 represents time, and the ordinate represents the emission power for the laser detection signal. As shown in FIG. 8, in the first measurement cycle, the current emission block is first controlled to emit the laser detection signal first time with the first preset emission power (the first preset emission power in FIG. 8 is adjustable power). Then based on the first echo signal corresponding to the laser detection signal emitted first time, it is determined whether the laser detection signal needs to be emitted second time, and if the laser detection signal needs to be emitted second time, the emission power for emitting the laser detection signal second time is adjusted based on the first echo signal corresponding to the laser detection signal emitted first time and so on until the measurement is completed.

In the LiDAR controlling method provided in the embodiments of this application, the number of emissions of laser detection signals performed by the current emission block and the emission power for emitting the laser detection signal each time can be adjusted based on the current measurement scenario, so that the emitted laser detection signal can meet a requirement for the current measurement scenario. By adjusting the number of emissions of the laser detection signals performed by the current emission block and the emission power for emitting the laser detection signal each time, the LiDAR can meet performance requirements such as the ranging performance, the ranging accuracy, and the high anti-expansion performance in various measurement scenarios, thereby improving the measurement performance of the LiDAR.

In an embodiment, the LiDAR controlling method may further include the following steps: adjusting the emission policy of the current emission block in a next measurement cycle based on a measurement result in the current measurement cycle.

In an embodiment, determining the emission policy of the current emission block in a next measurement cycle based on all echo signals received in the current measurement cycle may include: adjusting the number of emissions and emission power of the current emission block in the next cycle based on one or more of parameters such as echo amplitude of the echo signal (signal strength of the echo signal), echo pulse width of the echo signal, and the distance between the LiDAR and the target object.

In an embodiment, the smaller the distance between the LiDAR and the target object, the lower the required emission power and the lower the number of emissions. Therefore, in this case, the number of emissions in the next measurement cycle and the emission power during each emission can be reduced. The greater the distance between the LiDAR and the target object, the higher the required emission power and the higher the number of emissions. Therefore, in this case, the number of emissions in the next measurement cycle and the emission power during each emission can be increased.

The stronger the received echo amplitude, the lower the required emission power and the smaller the number of emissions. Therefore, in this case, the number of emissions and the emission power during each emission in the next measurement cycle can be reduced. The weaker the echo amplitude, the higher the required emission power and the larger the number of emissions. Therefore, in this case, the number of emissions and the emission power during each emission in the next measurement cycle can be increased.

The greater the echo pulse width, the lower the required emission power and the lower the number of emissions. Therefore, in this case, the number of emissions and the emission power during each emission in the next measurement cycle can be reduced. The smaller the echo pulse width, the higher the required emission power and the larger the number of emissions. Therefore, in this case, the number of emissions and the emission power during each emission in the next measurement cycle can be increased.

In an embodiment, when it is determined that an object at a short distance is detected based on the echo signal, the emission power in the next measurement cycle can be reduced to ensure safety of human eyes. In a case where the emission power is reduced and the echo amplitude becomes smaller, the number of superpositions can be increased to ensure sufficient measurement accuracy and detection rate.

In an embodiment, assuming that the echo amplitude is excessively small, the emission power can be increased at this time. After the emission power is increased, in a case where energy of the echo amplitude becomes high enough, the measurement accuracy and detection rate meet the design requirement at this time, and therefore, the number of superpositions can be reduced, to reduce power consumption of the entire device.

In an embodiment, the reducing the emission power can be reducing the emission power based on preset unit power, that is, the emission power is reduced by preset unit power each time; and the increasing emission power can also be increasing the emission power based on preset unit power, that is, the emission power is increased by preset unit power each time.

Reducing the emission power may also include: determining a power adjustment target value that needs to be reduced based on a difference between the echo intensity of the echo signal and the saturation intensity threshold, and then controlling the LiDAR to reduce the foregoing power adjustment target value based on the initial emission power. Increasing the emission power may also include: determining a power adjustment target value that needs to be increased based on a difference between the echo intensity of the echo signal and the measurement intensity threshold, and then controlling the LiDAR to increase the foregoing power adjustment value based on the initial emission power.

The foregoing method for increasing and reducing the emission power can refer to other methods for adjusting the power of the LiDAR and is not limited in this application.

The foregoing preset unit power can be set according to actual application and is not limited in this application.

Determining a power adjustment target value that needs to be reduced based on a difference between the echo intensity of the echo signal and the saturation intensity threshold and determining a power adjustment target value that needs to be increased based on a difference between the echo intensity of the echo signal and the measurement intensity threshold may include: presetting a corresponding relation between the difference and the power adjustment target value, and searching for the corresponding power adjustment target value based on the difference.

In an embodiment, after the LiDAR determines the emission policy in the next measurement cycle, when the detection task in the next measurement cycle is started, the detection signal can be emitted as per the number of emissions of detection signals and the emission power for emitting detection signals each time in the emission policy.

In an embodiment, because the LiDAR emits laser detection signals multiple times in the same measurement cycle, the LiDAR receives multiple echo signals. The measurement result in the current measurement cycle needs to be analyzed based on the multiple echo signals.

In an embodiment, analyzing the measurement result based on all the echo signals may include: superimposing all the echo signals, and analyzing the measurement result by using a superimposed echo signal.

For a method of analyzing the measurement result based on the echo signal, refer to currently existing solutions. For example, in a flash LiDAR, histograms in multiple emissions are superimposed, and for the echo signals received by each receiving planar array, histograms are superposed and data is processed to obtain a result viewed as a whole. Optionally, during processing of the echo signal, for the echo signals received by some receiving units in the receiving planar array, histograms can also be superimposed to obtain a result. A procedure of processing the echo signal and analyzing the result is not limited in this application, and can be adjusted based on different LiDAR systems and different detection requirements.

Emitting laser detection signals multiple times in the same measurement cycle and then analyzing the corresponding measurement result by using the echo signals corresponding to the multiple laser detection signals can effectively improve accuracy of the measurement result.

In an embodiment, to avoid a problem of signal crosstalk between multiple detection signals emitted within the same measurement cycle, the LiDAR controlling method provided in this embodiment of this application may also include the following step: adding a preset time delay after a detection signal is emitted each time.

In an embodiment, each emission time is jittered, that is, a different preset time delay is added after each emission time, so that there are different time deviations between each emission moment and scanning time, to avoid crosstalk between multiple detection signals.

Certainly, in addition to dithering the emission time to avoid the crosstalk between the multiple detection signals, an emission sequence of the detection signals can also be adjusted. That is, when a multi-channel receiving module and emission module work, a sequence of different receiving and emission modules is adjusted, so that there is no crosstalk between the received signals.

A sequence number of each step in the foregoing embodiments does not mean an execution sequence. An execution sequence of each process should be determined based on a function and internal logic of each process, and should not constitute any limitation to an implementation process of the embodiments of this application.

Based on the LiDAR controlling method provided in the foregoing embodiment, embodiments of the present disclosure further provide an embodiment of a LiDAR controlling apparatus for implementing the foregoing method embodiment.

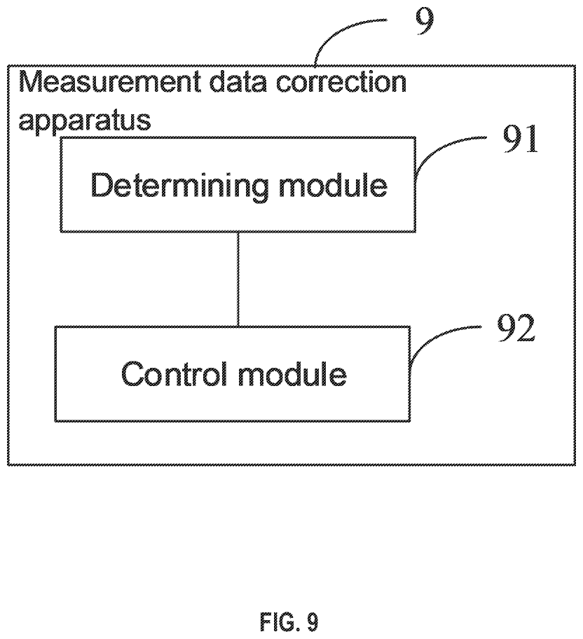

In an embodiment, FIG. 9 is a schematic structural diagram of a LiDAR controlling apparatus according to an embodiment of this application. In this embodiment of this application, each unit included in the LiDAR controlling apparatus is configured to perform each step in the embodiment corresponding to FIG. 2. For details, refer to FIG. 2 and related descriptions in the embodiment corresponding to FIG. 2. For ease of description, only a portion related to this embodiment is shown. As shown in FIG. 9, the LiDAR controlling apparatus 9 includes a determining module 91 and a control module 92.

The determining module 91 is configured to obtain an emission policy of a current emission block based on a current measurement scenario, where the emission policy includes the number of emissions performed by the current emission block and emission power for emitting a laser detection signal each time.

The control module 92 is configured to be used by the LiDAR to control the current emission block to emit the laser detection signal based on the emission policy.

In an embodiment, the foregoing emission block includes one or more emission units.

In an embodiment, the foregoing LiDAR includes an emission array. The foregoing emission array includes several groups of parallel emission blocks, and each group of parallel emission blocks emit laser detection signals via the same emission policy.

In this embodiment, when the emission array uses a planar array for emission, emission blocks located in different regions have different emission policies.

In an embodiment, the LiDAR controlling apparatus 90 further includes an adjustment module.

The foregoing adjustment module is configured to adjust the emission policy of the current emission block in a next measurement cycle based on a measurement result in the current measurement cycle.

In an embodiment, when the foregoing emission policy is the first emission policy, the control module 92 is configured to control the current emission block to emit the laser detection signal at least twice, where the emission power for emitting the laser detection signal each time is fixed power, and equal emission power is used for emitting the laser detection signal each time.

In an embodiment, when the foregoing emission policy is the second emission policy, the control module 92 is specifically configured to control the current emission block to emit the laser detection signal at least twice, where the emission power for emitting the laser detection signal each time is fixed power, and different emission power is used for emitting the laser detection signal each time.

In an embodiment, when the foregoing emission policy is the third emission policy, the control module 92 is configured to adjust a subsequent emission policy based on a first echo signal in a current detection cycle, where the first echo signal is an echo signal received by the LiDAR when a laser detection signal is emitted for the first time in the current detection cycle.

In an embodiment, the control module 92 is further configured to: determine whether the foregoing first echo signal meets a detection requirement; and if the foregoing first echo signal meets the detection requirement, stop emitting the laser detection signal; or if the foregoing first echo signal does not meet the detection requirement, perform steps of adjusting the emission power for the laser detection signal based on the foregoing first echo signal, and emitting the laser detection signal based on the adjusted emission power.

Content such as information exchange and an execution process between the foregoing units is based on the same concept as the method embodiments of this application. For functions and technical effects thereof, reference may be made to the method embodiments.

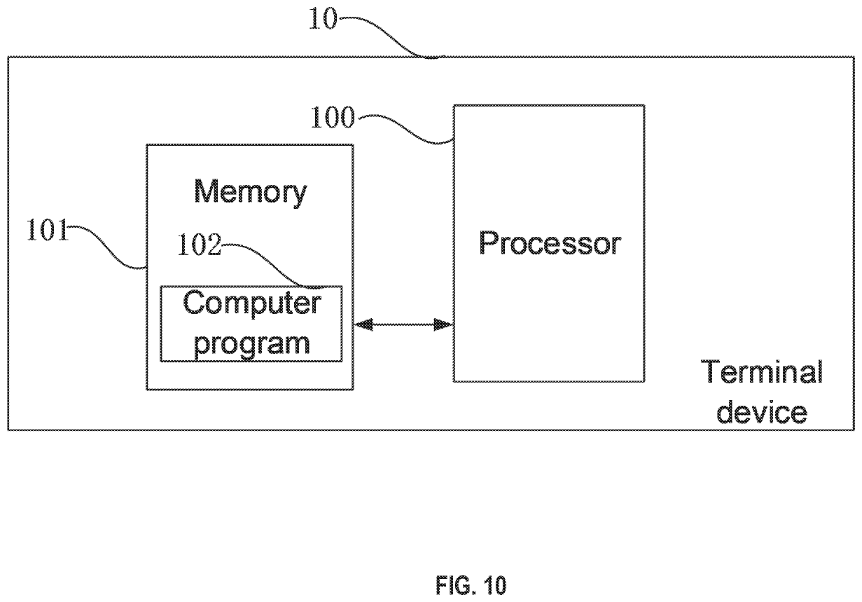

FIG. 10 is a schematic structural diagram of a terminal device according to another embodiment of this application. As shown in FIG. 10, the terminal device 10 provided in this embodiment includes: a processor 100, a memory 101, and a computer program 102 stored in the memory 101 and capable of running on the processor 100, for example, an image segmentation program. When executing the computer program 102, the processor 100 performs the steps in each embodiment of the LiDAR controlling method, for example, step S11 to step S12 shown in FIG. 2. Alternatively, when executing the computer program 102, the processor 100 implements functions of the modules or units in each embodiment of the terminal device, for example, functions of the units 91 to 92 shown in FIG. 9.

For example, the computer program 102 may be divided into one or more modules or units, and the one or more modules or units are stored in the memory 101 and are performed by the processor 100 to complete this application. The one or more modules or units may be a series of computer program instruction fields capable of completing specific functions, and the instruction fields are used to describe an execution process of the computer program 102 in the terminal device 10. For example, the computer program 102 may be divided into a plurality of units. For specific functions of the units, refer to relevant descriptions in the embodiment corresponding to FIG. 11. Details are described herein again.

The terminal device may include the processor 100 and the memory 101. A person skilled in the art can understand that FIG. 10 is only an example of the terminal device 10, and does not constitute a limitation to the terminal device 10. The terminal device may include more or fewer components than those shown in the figure, or a combination of some components, or different components. For example, the terminal device may also include input and output devices, a network access device, a bus, and the like.

The processor 100 may be a central processing unit (CPU), or maybe another general-purpose processor, a digital signal processor (DSP), an application specific integrated circuit (ASIC), a field-programmable gate array (FPGA) or another programmable logic device, a discrete gate or transistor logic device, a discrete hardware component, or the like. The general-purpose processor can be a microprocessor, or the processor can be any conventional processor or the like.

The memory 101 may be an internal storage unit of the terminal device 10, such as a hard disk or a memory of the terminal device 10. The memory 101 may alternatively be an external storage device of the terminal device 10, for example, a plug-connected hard disk, a smart media card (Smart Media Card, SMC), a secure digital (Secure Digital, SD) card, or a flash card (Flash Card) equipped on the terminal device 10. Further, the memory 101 may alternatively include both the internal storage unit and the external storage device of the terminal device 10. The memory 101 is configured to store the computer program and other programs and data required by the terminal device. The memory 101 can also be configured to temporarily store output data or to-be-output data.

An embodiment of this application also provides a computer-readable storage medium. The computer-readable storage medium stores a computer program, and when the computer program is executed by the processor, the foregoing LiDAR controlling method can be implemented.

An embodiment of this application provides a computer program product, where when the computer program product runs on a terminal device, the terminal device performs the foregoing LiDAR controlling method.

For ease and brevity of description, division of the foregoing functional units and modules is taken as an example for illustration. In actual application, the foregoing functions can be allocated to different units and modules and implemented according to a requirement, that is, an inner structure of the terminal device is divided into different functional units and modules to implement all or a part of the functions described above. The functional units and modules in the embodiments may be integrated into one processing unit, or each unit may exist alone physically, or two or more units may be integrated into one unit. The integrated unit may be implemented in a form of hardware, or may be implemented in a form of a software functional unit. In addition, specific names of the functional units and modules are only for the convenience of distinguishing one another, and are not intended to limit the protection scope of this application. For a detailed working process of units and modules in the foregoing system, reference may be made to a corresponding process in the foregoing method embodiments.

In the foregoing embodiments, the descriptions of the embodiments have respective focuses. For a part that is not described in detail in one embodiment, reference may be made to related descriptions in other embodiments.

The units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions.

What is claimed is:

1. A LiDAR controlling method, comprising:
obtaining an emission policy of a current emission block based on a current measurement scenario, wherein the emission policy comprises a number of emissions performed by the current emission block and emission power for emitting a laser detection signal each time; and
controlling, by the LiDAR, the current emission block to emit the laser detection signal based on the emission policy.

2. The LiDAR controlling method according to claim 1, wherein the emission block comprises one or more emission units.

3. The LiDAR controlling method according to claim 1, wherein the LiDAR comprises an emission array, the emission array comprises several groups of parallel emission blocks, and each group of parallel emission blocks emit laser detection signals via the same emission policy.

4. The LiDAR controlling method according to claim 3, wherein when the emission array uses a planar array for emission, emission blocks located in different regions have different emission policies.

5. The LiDAR controlling method according to claim 1, wherein after the controlling, by the LiDAR, the current emission block to emit the laser detection signal based on the emission policy, the method further comprises:
adjusting the emission policy of the current emission block in a next measurement cycle based on a measurement result in a current measurement cycle.

6. The LiDAR controlling method according to claim 1, wherein when the emission policy is a first emission policy, the controlling the current emission block to emit the laser detection signal based on the emission policy comprises:
controlling the current emission block to emit the laser detection signal at least twice, wherein the emission power for emitting the laser detection signal each time is fixed power, and equal emission power is used for emitting the laser detection signal each time.

7. The LiDAR controlling method according to claim 1, wherein when the emission policy is a second emission policy, the controlling the current emission block to emit the laser detection signal based on the emission policy comprises:
controlling the current emission block to emit the laser detection signal at least twice, wherein the emission power for emitting the laser detection signal each time is fixed power, and different emission power is used for emitting the laser detection signal each time.

8. The LiDAR controlling method according to claim 1, wherein when the emission policy is a third emission policy, the controlling the current emission block to emit the laser detection signal based on the emission policy comprises:
adjusting a subsequent emission policy based on a first echo signal in a current detection cycle, wherein the first echo signal is an echo signal received by the LiDAR when the laser detection signal is emitted for a first time in the current detection cycle.

9. The LiDAR controlling method according to claim 8, wherein before adjusting the subsequent emission policy based on the first echo signal in the current detection cycle, the method further comprises:
determining whether the first echo signal meets a detection requirement; and
if the first echo signal meets the detection requirement, stopping emitting the laser detection signal; or
if the first echo signal does not meet the detection requirement, adjusting the subsequent emission policy based on the first echo signal in the current detection cycle.

10. A LiDAR controlling apparatus, comprising:
a determining module, configured to obtain an emission policy of a current emission block based on a current measurement scenario, wherein the emission policy comprises a number of emissions performed by the current emission block and emission power for emitting a laser detection signal each time; and
a control module, configured to be used by the LiDAR to control the current emission block to emit the laser detection signal based on the emission policy.

11. A terminal device, comprising a memory, a processor, and a computer program stored in the memory and capable of running on the processor, wherein when the processor executes the computer program, a LiDAR controlling method is implemented, wherein the LiDAR controlling method comprises:
obtaining an emission policy of a current emission block based on a current measurement scenario, wherein the emission policy comprises a number of emissions performed by the current emission block and emission power for emitting a laser detection signal each time; and
controlling, by the LiDAR, the current emission block to emit the laser detection signal based on the emission policy.
